(19) United States
(12) Patent Application Publication
(10) Pub. No.: US 2004/0065012 A1
(43) Pub. Date: Apr. 8, 2004

(54) Water and air retaining flower and landscape planter pot method and apparatus

(76) Inventor: Joe Don Byles, New Braunfels, TX (US)

Correspondence Address: JOE D. BYLES, 20 TIMBER MEADOW, NEW BRAUNFELS, TX, 78132, US

(21) Appl. No.: 10/664,377

(22) Filed: Sep. 17, 2003

Related U.S. Application Data
(60) Provisional application No. 60/411,624, filed on Sep. 18, 2002.

(51) Int. Cl. A01G 25/00

(52) U.S. Cl. 47/80

(57) ABSTRACT

A water and air retaining flower and landscape planter pot for display inside and outside of the home which provides adequate reservoir of air and water for the sustenance of these plants with extended times between required waterings. The novel planter pot also does not require drain holes to keep adequate air within the growing structure.

### CROSS REFERENCE TO RELATED APPLICATION

This application claims the benefit of prior art provisional application Ser. No. 60/411,624, entitled WATER AND AIR RETAINING FLOWER AND LANDSCAPE PLANTER POT METHOD AND APPARATUS.

### BACKGROUND OF THE INVENTION

This invention relates to means and methods of providing air and water to potted plants for display inside and outside of the home, and more specifically to providing an adequate reservoir for the sustenance of these plants with extended times between required waterings.

For many people who live in smaller multi-family dwellings such as apartment and condominiums the art and hobby of gardening is usually confined to the realm of growing containerized, potted plants within the home or on a small concrete patio. While there have been many prior art advancements to help none have significantly reduced the labor of watering these plantings or the skill required in maintaining a optimum balance of air, water and nutrients.

The foremost problem with maintaining plant life within a pot on a patio or in a home is the requirement of keeping an adequate moisture reserve for the plant material in the pot. Because the soil is usually set on solid concrete or within a house and only has access to the soil contained with the pot, the plants tend to dry out and need watering as frequently as two to three times a week and sometimes everyday. The daily water requirement of the potted plant material, or the plant evapotranspiration (water lost through evaporation and transpiration of the plant), can sometimes exceed the water holding capacity of the soil in the pot. For instance, a foot of sandy loam soil has approximately 7/10 of an inch of available water per foot of soil. If a plant is in a pot that is 8 inches high with a sandy loam soil, the available water is 8 divided by 12 times 7/10 of an inch of water, or 0.4666 inches of available water in the pot. If the plant had a daily evapotranspiration of 0.5 inches, the pot would need to be watered to field capacity every single day. By using larger and deeper pots, the timing of watering can be stretched but rarely by more that two or three days. By definition the maximum amount of water that can be stored in the soil contained within the pot is field saturation, or the amount held against gravity, as the pots that the plants are contained in must have a plurality of drainage holes to allow excess water that exceeds field capacity the ability to drain off. If the drainage holes were not present then all air contained in the soil would be driven out and the there would be no oxygen available to the plant, the soil would be in a fully saturated condition. The plant would drown and die. In fact, the overwatering of plants to the point of no oxygen is a common problem for potted plants. It is just as critical to have an ample supply of oxygen as it is to have an ample supply of water at the root zone of the plant.

In an attempt to provide a means to supply water to plants and extend the water holding capacity of pots without eliminating oxygen, several prior art products have been developed. One such product is a crystaline polymer gel which, when mixed into the soil of the potted plant, absorbs up to 400 times the crystals weight in water and holds it until needed by the roots of the plant. This material does increase the amount of water that is held in the soil mix of the container, but at the expense of area which could be utilized for oxygen. Also, the gel must release the water to the roots or the soil and then into the roots. It is unclear as to the effectiveness in this release of water to the plant for this purpose. In several articles written, it has been noted that the use of these polymer gels can increase the length of time between waterings but only at a fractional level. Also, the increase in cost associated with the polymer gels and general availability greatly reduce the application of these items.

Other forms of prior art technologies which attempt to lengthen the time between waterings of potted plants are forms of wicking materials placed in a secondary water supply and then the wicking material being fed into the soil of the potted plant so as to draw the water from the reservoir up and into the potted plant. In one common prior art application the water container is secondary to the pot with the soil and plant with the wick material being placed in the secondary water source and then placed in the soil of the potted plant, drawing water to the soil as it dries out. This technology allows for the soil to maintain a balance of air and water but has the drawback of requiring a secondary water container to be filled. There are many variations of this technology where the water holding reservoir is hidden within the potted plant and the water is added to the hidden container within the pot. This system does extend the time between waterings but is still limited by physical constraints of having two separate containers, one for the water and one for the potted plant.

All in all, no one prior art method or product for providing extended supplies of water to a potted plant has been developed which is easy to use, inexpensive and provides oxygen to the plant with water all in one container.

### SUMMARY OF THE INVENTION

It is therefore a general objective of the current invention to overcome the above described limitations and problems associated with prior art systems and methodologies for providing extended watering periods to potted plants inside the house and outside on the patio.

In order to accomplish the objectives of the current invention, the system apparatus according to the invention includes in one preferred embodiment a water tight sealed pot of any suitable material such as plastic, sealed clay pottery, expanded closed cell foam or any formable material which is non-permeable or with a very low permeability to water. Inside of this water-tight non-permeable or partially permeable pot, container or recipticle is placed a porous, open celled material which is manufactured in such a way that the cells of the material are partially blocked and partially open with webs. A suitable example of this material would be a polyether polyurethane, non-reticulated material with 40 pores per inch and a 4 lb per cubic foot density. This material provides an environment suitable for roots of plants to grow through the non-reticulated partially blocked cells of the material. The material is formed so that it conforms to the inside shape of the pot with a significant amount of the material in the container or pot. On the upper surface of the non-reticulated polyether polyurethane is a depression or hole that is on the upper surface and goes into the material but not all the way to the bottom or sides of the material, such that there is a continuous area of the polyether polyurethane material in contact with the non-porous pot. The hole in the top of the open-cell polyether polyurethane is suitable and of the right size for the root structure and some supporting soil of a plant to be located within the hole.

For setting up the water and air retaining planter pot a plant of appropriate size is located into the hole which is contained in the top of the non-reticulated polyether polyurethane which is contained in the water tight, non-permeable container pot. The polyether polyurethane material is then covered with mulch and water is applied to the top of the pot to fully fill the planter pot to the top.

### THEORY OF OPERATION

The water and air retaining planter operates under the following principle of air and water retention. The plant is planted in the hole in the top of the non-reticulated polyether polyurethane material. The root ball consists of a mass of roots of the plant and binding soil that is present in the purchased plant. The plant is placed in the hole so that approximately 30% of the plant rootball roots and soil are located above the top surface of the non-reticulated polyether polyurethane material. The root ball roots and soil are firmly in contact with the inner surface of the hole in the polyether polyurethane material. The area above the polyether polyurethane material is then filled with a suitable mulch material to cover the entire top surface of the polyether polyurethane material and the top of the rootball roots and soil. Once the plant is properly placed in the polyether polyurethane material and the mulch is located on top of the plant root ball and surrounding polyether polyurethane material water can be added to the planter pot/polyether polyurethane/plant combination into the polyether material from the top through the mulch. The water is added until there is water standing at the very top of the planter pot and is visible. As the water is added to the non-reticulated polyether polyurethane material, tiny pockets of air are trapped within the cell structures of the foam material as tiny webs are present within the cell structure due to the non-reticulated structure of the foam. In a typical 1 inch of the foam nearly 1 inch of water is contained but also a large amount of tiny air pockets are retained creating a perfect air water combination for the roots of the planted plant to grow into and access water and air. The net result is that a one inch section of the material, even if fully submerged beneath water still contains one inch of usable water with a large number of air pockets submerged within. This trapping of the air within the cell structure allows for a sealed pot to be completely filled with water, and because all of the open space between the sealed container and the planted plant rootball is filled with the non-reticulated foam material an optimum mix of air and water is filled in the area where the roots will grow and fill in the pot. The net result is that if there is sixteen inches of foam beneath the rootball of the plant and bottom of the impermeable pot, when it is filled with water to the top the plant has access to the equivalent of sixteen inches of water AND air providing an optimum growing condition and an extended length of time between watering events. For instance, if a potted plant requires 0.5 inches of water per day, then the sixteen inches of water and air contained in the foam material would last 32 days between waterings (as opposed to 2 days if the planter was just filled with soil). If the plant requires one inch of water per week, then the potted plant can go 16 weeks, or approximately 4 months between waterings. What allows the filling of the pot without drainage holes, and therefore the most efficient watering, is the unique structure of the open-celled non-reticulated polyether polyurethane foam which also traps air within the structure of the membrane. If a sealed pot was filled with soil and then filled with water, there would be no air in the soil and the plant would die from lack of air. Also, the structure of the open celled foam allows for one inch of water to be contained in approximately one inch of foam, where soil, due to limited pore space, containes one inch of water per one foot of soil material. Therefore to make a pot which was watered only once every 16 weeks would have to contain a depth of 16 feet and have the plant roots go 16 feet deep, this obviously not being possible. As the roots of the root ball completely fill the open-celled foam material and access all of the air and water available, the length between waterings can be dramatically increased over those for a convention soil filled potted plant.

A summary of the benefits of the water and air retaining planter are as follows:

1. Greatly extended lengths of time between plant waterings.

2. No drainage holes needed (and subsequent loss of water) due to air entrapment within the membrane structre.

3. Optimum rooting material for the roots of the potted plant to grow into.

4. Optinum water and oxygen stored in the growing medium.

5. Only air storing medium which still store air fully submerged under water.

6. The pot without water is lightweight compared with conventional sands or soils.

The above listed benefits and features, considered with the planter pot descriptions from above will become more evident when considered with the following drawings and descriptions.

### BRIEF DESCRIPTION OF THE DRAWINGS

FIG. 1 shows a cross section of a typical planter pot with the water tight pot, open celled polyether polyurethane material and planted plant.

### DESCRIPTION OF THE PREFERRED EMBODIMENTS

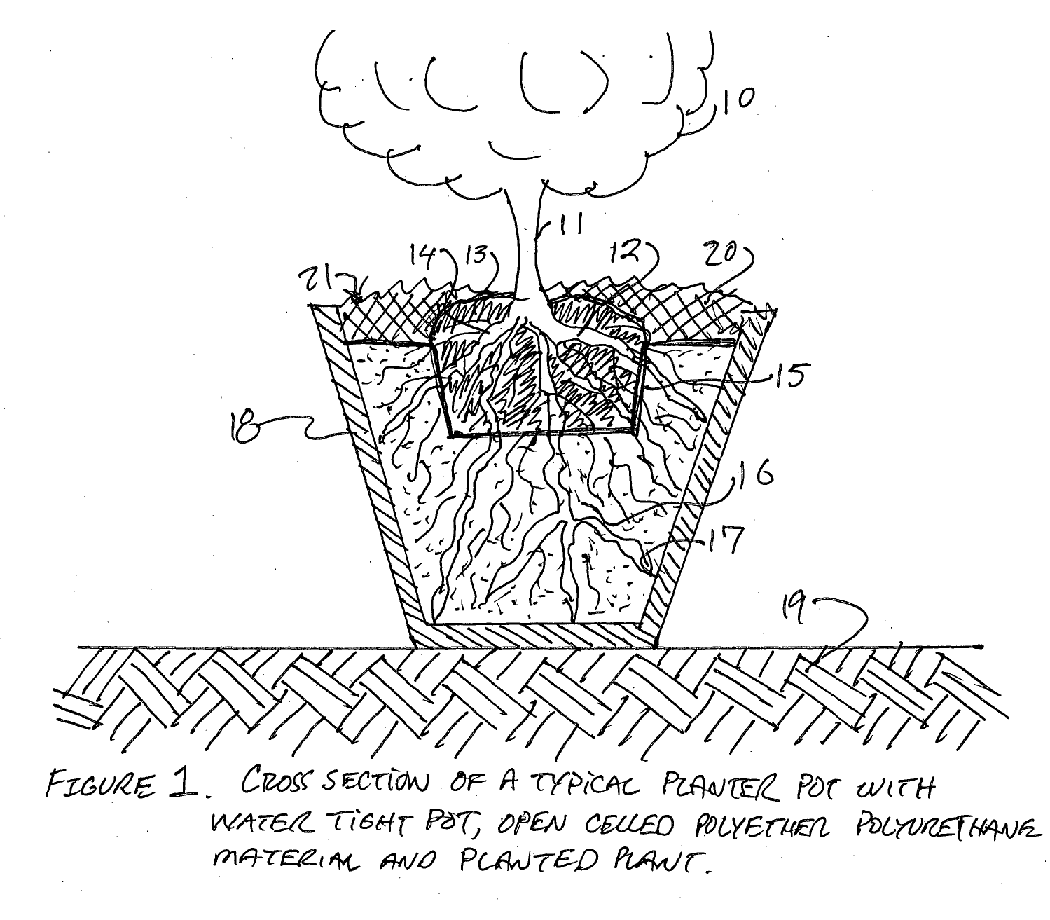

FIG. 1 shows a cross section of a typical planter pot with the water tight pot, open celled polyether polyurethane material and planted plant. The plant 10 has a stem 11 which extends down to a rootball 12 consisting of soil 13 and roots 14. The rootball 12 is placed into a blind, circular hole 15 cut into the open celled, polyether polyurethane, non-reticulated foam 16. The foam 16 is conformed to the inside shape 17 of the water tight pot 18. The water tight pot 18 has no drainage holes in its bottom. The pot assembly is located on a hard surface 19 which could be any suitable surface for placement of the pot 18. The roots of the rootball 14 grow through the soil 13 of the rootball and into the foam 16 into which the root ball is planted to the inner sides of the pot 17. The entire rootball 12 and foam 16 are covered with mulch 20 on the upper surface of the pot. 18. Water and air fills the pot 18 to the upper surface of the mulch 21 and the roots of the plant access the water and air in the foam section of the planting 16.

The above described preferred embodiments are intended to illustrate the principles of the invention, but not to limit the scope of the invention. Various other embodiments and modifications to these embodiments may be made by those skilled in the art without departing from the scope of the invention as described.

What is claimed is:

1. A method of maintaining an air and water reservoir within a closed, sealed planter pot, the method comprising the steps of:
postiontioning a porous and permeable water and air holding structure capable of holding air within the material in a completely submerged water condition within a closed and sealed portion of the planter pot such that roots of a plant located above the material can grow into the porous and permeable water and air holding structure and access air and water.

2. The method of claim 1 further comprising the step of:
adding drain holes to the closed sealed planter pot at a level where conventional potting soil of a planted plant interfaces with the upper surface of the porous and permeable water and air holding structure, so as to allow the conventional potting soil to be in a constantly drained state and the porous and permeable water and air holding structure to be in a state sealed from drainage.

3. The method of claim 2 further comprising the step of:
creating drain holes at a level where conventional potting soil of a planted plant interfaces with the upper surface of the porous and permeable water and air holding structure by providing air and water tight passages which extend from the bottom of the porous and permeable water and air holding structure to the soil interface, providing a open channel from the bottom of the soil layer to the bottom of the pot while maintaining the permeable water and air holding structure in a sealed state from drainage.

4. A method of planting a plant within a planter pot, the method comprising the steps of:
placing a plant directly onto a porous and permeable water and air holding structure which is located within a sealed pot.

5. A method of planting a plant with a planter pot, the method comprising the steps of:
placing a plant into a receiving pocket within a porous and permeable water and air holding structure with a sealed pot.

6. The method of claim 4 further comprising the step of:
placing a decorative cover material on top of the porous and permeable water and air holding structure.

7. The method of claim 5 further comprising the step of:
placing a decorative cover material on top of the porous and permeable water and air holding structure.

8. The method of claim 1 further comprising the step of:
adding a water supply conduit to charge into the sealed a porous and permeable water and air holding structure at a controlled rate to provide water to the roots of the plant growing into the porous and permeable water and air holding structure.

9. A planter pot water and air holding apparatus incorporated into a sealed, water tight planter pot, the apparatus comprising:
a sealed water tight planter pot; and
a porous and permeable water and air holding structure capable of holding air within the material in a completely submerged water condition within a closed and sealed portion of the planter pot.

10. The apparatus of claim 9 in which the porous and permeable water and air holding structure capable of holding air within the material in a completely submerged is selected from a group consisting of an open cell foam material, non-reticulated or reticulated, a reticulated material, and a granular material.

11. The apparatus of claim 10 where the material is polyether polyurethane open cell, non-reticulated material.

12. The apparatus of claim 9 further comprising;
adding drain holes to the closed sealed planter pot at a level where conventional potting soil of a planted plant interfaces with the upper surface of the porous and permeable water and air holding structure, so as to allow the conventional potting soil to be in a constantly drained state and the porous and permeable water and air holding structure to be in a state sealed from drainage.

13. The apparatus of claim 12 further comprising:
at least one drain holeat a level where conventional potting soil of a planted plant interfaces with the upper surface of the porous and permeable water and air holding structure by providing air and water tight passages which extend from the bottom of the porous and permeable water and air holding structure to the soil interface, providing a open channel from the bottom of the soil layer to the bottom of the pot while maintaining the permeable water and air holding structure in a sealed state from drainage.

14. The apparatus of claim 9 further comprising:
adding a water supply conduit to charge into the sealed porous and permeable water and air holding structure at a controlled rate to provide water to the roots of the plant growing into the porous and permeable water and air holding structure.

15. The apparatus of claim 14 further comprising:
a flow controlled emission device inserted into the sealed porous and permeable water and air holding structure attached to the water supply conduit.
